(19) United States
(12) Patent Application Publication
(10) Pub. No.: US 2025/0256236 A1
(43) Pub. Date: Aug. 14, 2025

(54) COMBINATION OF ROTATABLE PRE-DRYING UNIT WITH CO2 RECOVERY

(71) Applicant: Volkswagen Aktiengesellschaft, Wolfsburg (DE)

(72) Inventors: Peter Kawelke, Wolfsburg (DE); Martin Hofer, Branschweig (DE); Christian Heimermann, Wolfsburg (DE); Marcel Wiegel, Gardelegen (DE); Christine Schütz, Vordorf (DE); Frank Beger, Hannover (DE); Marc Rüggeberg, Braunschweig (DE)

(21) Appl. No.: 19/046,273

(22) Filed: Feb. 5, 2025

(30) Foreign Application Priority Data
Feb. 9, 2024 (DE) 102024103685.0

(51) Int. Cl. B01D 53/06; B01D 53/04; B01D 53/26

(52) U.S. Cl. CPC B01D 53/06; B01D 53/0438; B01D 53/261; B01D 2257/504; B01D 2257/80; B01D 2258/06; B01D 2259/40088

(57) ABSTRACT

A device for recovering carbon dioxide from a gaseous medium includes a first air flow channel configured to direct the gaseous medium, a second air flow channel configured to direct exhaust air from the device, and at least one rotatable pre-drying unit including at least one sorbent for the physisorption of water. The at least one rotatable pre-drying unit is configured to rotate axially, with the first air flow channel controlling the rotatable pre-drying unit radially. Also described are a method for recovering carbon dioxide and the use of the device for recovering carbon dioxide.

### RELATED APPLICATIONS

The present application claims priority to German Patent App. No. 102024103685.0 to Kawelke et al., filed Feb. 9, 2024, the contents of which are incorporated by reference in its entirety herein.

### TECHNICAL FIELD

The present disclosure relates to a device for recovering carbon dioxide from a gaseous medium, a method for recovering carbon dioxide from a gaseous medium, and the application of the device and method for carbon dioxide recovery.

### BACKGROUND

The emission of carbon dioxide into the atmosphere is widely recognized as a significant contributor to climate change. Carbon capture and storage (CCS) technologies provide efficient and effective approaches for reducing carbon dioxide emissions.

Various methods for capturing carbon dioxide are known, including absorption, adsorption, membrane-based separation, electrochemical separation, and cryogenic separation.

One technical approach to carbon dioxide capture is direct air capture (DAC), in which carbon dioxide is extracted from ambient air using a separator. This process allows for the recovery of high-purity carbon dioxide that can be utilized in subsequent applications.

WO 2016/005226 A1, WO 2015/185434 A1, and WO 2014/170184 A1 describe methods for recovering carbon dioxide using a chemisorbent in a temperature-vacuum swing process. A challenge associated with amine-based chemisorbents is their tendency to degrade when exposed to oxygen at temperatures exceeding approximately 60° C. This degradation can occur during the desorption phase at temperatures around 100° C. unless preventive measures are implemented, such as maintaining an inert atmosphere using steam or other gases. However, these protective measures introduce complexity and increased costs. During desorption, steam is introduced to displace residual oxygen and mitigate material degradation. Additionally, before transitioning back to the adsorption phase, where carbon dioxide is captured, the sorbent material is cooled to approximately 50° C. This additional cooling step decreases the time and energy efficiency of the process.

Physisorbents generally exhibit a higher affinity for water than for carbon dioxide. As a result, systems employing physisorbents typically include a pre-drying mechanism to remove moisture from the air. However, such pre-drying systems introduce additional structural and energy demands.

WO 2022/109746 A1 discloses a method for recovering carbon dioxide using physisorbents in polar regions, where cold and dry conditions enhance adsorption performance. These materials preferentially absorb water from ambient air.

When using physisorbents, one potential approach is to restrict the system's application to polar regions, where lower temperatures naturally reduce atmospheric moisture levels compared to temperate, subtropical, or tropical zones. However, technical pre-drying remains necessary, as year-round dew point temperatures of −40° C. or −60° C. cannot be consistently maintained. Additionally, installing and operating a system in polar regions presents significant logistical and operational challenges compared to developed regions.

Knox et al., Investigation of Desiccants and CO₂ Sorbents for Exploration Systems 2016-2017, ICES-2017-188, describe the use of physisorbents for separating carbon dioxide from the cabin air of spacecraft and space stations. This reference discusses a four-bed molecular sieve approach, in which separate modules are used for pre-drying cabin air and for carbon dioxide separation.

EP 1 142 623 A2 discloses a temperature-vacuum swing process for isolating carbon dioxide from a humid, heated gas mixture.

US20100251887 A1 describes a method for isolating carbon dioxide from a gas mixture that involves a temperature swing adsorption step.

WO 2014/012966 A1 discloses a device configured for an adsorption-desorption swing process.

### SUMMARY

Aspects of the present disclosure relate to a device for recovering carbon dioxide from a gaseous medium and a method for recovering carbon dioxide from a gaseous medium, which at least partially address the challenges described above.

According to some aspects of the present disclosure, the described functionality is achieved through the independent claims of the present application, as detailed below. Additional aspects are set forth in the dependent claims, as well as in the description and drawings. Features, advantages, and potential implementations described in connection with one subject matter of the independent claims are to be understood as applicable, at least analogously, to other independent claims and any combination of independent and dependent claims.

In some examples, a device is provided for recovering carbon dioxide from a gaseous medium. The device includes a first airflow channel configured to direct the gaseous medium, a second airflow channel configured to direct exhaust air from the device, and at least one rotatable pre-drying unit comprising at least one sorbent for the physisorption of water. The at least one rotatable pre-drying unit is configured to rotate axially, and the first airflow channel is structured to control the at least one rotatable pre-drying unit radially.

In some examples, a method is provided for recovering carbon dioxide, comprising: directing a gaseous medium into a first airflow channel; pre-drying the gaseous medium in a rotating pre-drying unit; further drying the pre-dried gaseous medium in at least one drying unit; and adsorbing carbon dioxide from the dried gaseous medium in a carbon dioxide unit while simultaneously desorbing carbon dioxide in the carbon dioxide unit. The rotating pre-drying unit is configured to rotate axially, and the first airflow channel is structured to control the rotating pre-drying unit radially.

Preferably, the disclosed method is performed using the disclosed device. The features of the device may also be applicable to the method, enabling effective implementation.

A single device may be used to implement the disclosed method. Alternatively, at least two devices may be utilized, which can be arranged in parallel to enhance efficiency.

The disclosed method and device can be used in a direct air capture process for extracting carbon dioxide from ambient air.

In some examples, a process is disclosed for utilizing the disclosed device or method for recovering carbon dioxide from a gaseous medium.

The recovered carbon dioxide can serve as a feedstock for the synthesis of various compounds. For example, it may be used as a raw material in the production of plastics, e-fuels, and other chemical products.

### BRIEF DESCRIPTION OF THE DRAWINGS

Exemplary embodiments of the present disclosure will now be described by way of example with reference to the accompanying drawings, in which:

FIG. 1 schematically illustrates an exemplary embodiment of a rotatable pre-drying unit, according to some aspects of the present disclosure;

FIG. 2 schematically illustrates an exemplary embodiment of a coating of a rotatable pre-drying unit, according to some aspects of the present disclosure;

FIG. 3 schematically illustrates an exemplary embodiment of a device for recovering carbon dioxide, according to some aspects of the present disclosure;

FIG. 4 schematically illustrates another exemplary embodiment of a device for recovering carbon dioxide, according to some aspects of the present disclosure; and

FIG. 5 schematically illustrates an exemplary embodiment of a method for recovering carbon dioxide, according to some aspects of the present disclosure.

### DETAILED DESCRIPTION

As disclosed herein, a gaseous medium may include atmospheric air, ambient air, exhaust gases (e.g., from industrial plants), gas mixtures, point sources, or other similar compositions. The gaseous medium comprises, inter alia, carbon dioxide (CO₂). In some examples, the gaseous medium is ambient air, which is also referred to herein as air.

The device according to some aspects of the present disclosure includes a first airflow channel configured to direct the gaseous medium. The gaseous medium introduced into the first airflow channel may be process air.

The device further includes a second airflow channel for directing exhaust air from the device. The exhaust air is preferably a moist gaseous medium from which carbon dioxide has been removed.

Furthermore, the device includes at least one rotatable pre-drying unit comprising at least one sorbent for the physisorption of water. The at least one rotatable pre-drying unit is configured to rotate axially, and the first airflow channel is structured to control the at least one rotatable pre-drying unit radially.

As used herein, “rotatable” means that the pre-drying unit is installed in such a manner that it can rotate about its own axis and preferably rotates about its own axis during operation.

The rotatable pre-drying unit is preferably a sorption wheel or a sorption heat exchanger. A sorption wheel is a wheel-shaped structural component having an outer surface coated with a sorbent. The sorption wheel or the sorption heat exchanger is configured to rotate while a gaseous medium flows toward it, allowing a specific substance to be sorbed by the sorbent.

The device may include a single rotatable pre-drying unit. Alternatively, the device may include at least two rotatable pre-drying units, which may be arranged in parallel and/or in series.

The at least one rotatable pre-drying unit is configured to rotate axially, meaning that it rotates about its own axis. The first airflow channel is structured to control the at least one rotatable pre-drying unit radially, thereby directing the gaseous medium in a radial direction.

The sorbent for the physisorption of water is preferably disposed on the circumferential surface of the rotatable pre-drying unit, such that the first airflow channel directly controls the sorbent, allowing the gaseous medium flowing through the first airflow channel to come into direct contact with the sorbent.

As the rotatable pre-drying unit rotates, a portion of its surface comes into contact with the gaseous medium. The sorbent on this portion of the rotatable pre-drying unit absorbs at least a portion of the moisture (i.e., water) contained in the gaseous medium. Due to continuous rotation, the pre-drying unit moves such that the moisture-laden portion transitions to a regeneration region, where the sorbent is dried. The drying process is facilitated by the introduction of regeneration air. As the rotation continues, the dried sorbent is reintroduced into the airflow path, allowing it to absorb additional moisture. Consequently, pre-dried gaseous medium exits the rotatable pre-drying unit.

In some examples, the process and regeneration air primarily flow in a radial direction.

The portion of the rotatable pre-drying unit that comes into contact with the gaseous medium may constitute up to 50% of the circumferential surface of the rotatable pre-drying unit, preferably up to 30%, and more preferably up to 25%.

The radial flow arrangement provides advantages due to the presence of a higher water partial pressure in the outer radial region of the circumferential surface on the drying side. As a result, moisture adsorption (i.e., the absorption of water from the gaseous medium) occurs effectively even at lower flow rates. As the radius decreases, the water partial pressure decreases due to progressive water adsorption. Simultaneously, the flow rate increases, thereby improving adsorption kinetics and enabling effective drying even at lower water partial pressures.

The device may include at least one pre-conditioning unit. A pre-conditioning unit is a structural component configured to modify the gaseous medium before it interacts with other components, such as the at least one rotatable pre-drying unit. For example, a pre-conditioning unit may adjust the temperature of the gaseous medium by heating or cooling it. Additionally or alternatively, the pre-conditioning unit may alter the pressure of the gaseous medium by compressing or expanding it.

The inclusion of a pre-conditioning unit enables the device to operate effectively under varying climatic conditions (e.g., environments with higher water vapor content, elevated temperatures, or increased humidity levels).

In some examples, the device further includes at least one drying unit and at least one CO₂ unit.

In the drying unit, the pre-dried gaseous medium can be further dried to a specific moisture content. The drying unit preferably includes at least one material configured to regulate the moisture content. The material may be homogeneously distributed within the drying unit or arranged in layers. In particular, when the drying unit is structured in layers, it may establish a drying gradient. A first layer may facilitate an initial drying to a specified moisture content, while a subsequent layer enables further drying. The drying unit may comprise any number of layers, with the layers ideally coordinated for optimal performance.

The drying unit preferably adsorbs at least 99.0% of the water present in the gaseous medium, corresponding to a dew point of approximately −40° C.; more preferably, at least 99.7% (dew point −50° C.); and even more preferably, at least 99.9% (dew point −60° C.).

The drying unit may comprise at least four modules, wherein at least one module functions as a desorption module, at least two modules function as thermal displacement modules, and at least one module functions as an adsorption module. Each module may be independently structured with a suitable drying material. Preferably, all modules within the drying unit are identically structured with the appropriate drying material or materials.

The number of modules within the drying unit may be a multiple of the stated individual modules.

A desorption module, as used herein, refers to a structural unit configured to desorb and, preferably, also to adsorb a substance. The substance may be water (H₂O). Following desorption, the desorption module may be repurposed, for example, as an adsorption module or as a thermal displacement module.

An adsorption module refers to a structural unit configured to adsorb and, preferably, also to desorb a substance. The substance may be water (H₂O). Following adsorption, the adsorption module may be repurposed as a desorption module or a thermal displacement module.

A thermal displacement module refers to a structural unit capable of dissipating or absorbing heat. Depending on the phase of operation, the thermal displacement module may either absorb or release heat. During the thermal displacement phase preceding the desorption phase, the module can absorb heat from another module in the thermal displacement phase that is emitting heat. For example, a thermal displacement module may be a former adsorption module. The adsorption of a substance in an adsorption module may result in localized heat accumulation, increasing the module's temperature. This heat is preferably dissipated and reused in another module to facilitate the desorption of an adsorbed substance. Heat transfer may occur through airflow or other means.

The drying unit may comprise at least four modules. In alternative embodiments, the drying unit may include more than four modules. The number of modules is preferably selected to ensure a constant mass flow through the device.

The number of thermal displacement modules within the drying unit may be equal to the sum of the desorption modules and the adsorption modules in the drying unit. The total number of modules may be represented by the following equation:

$$Number of drying modules = x desorption modules + y adsorption modules + z thermal displacement modules$$

wherein z=2 or an integer multiple of 2.

The drying unit may include two drying modules in thermal displacement, with one module transferring heat and the other module receiving heat.

The drying unit may be structurally independent of the CO₂ unit.

The device may further comprise at least one CO₂ unit configured to adsorb a defined amount of carbon dioxide. The CO₂ unit preferably includes at least one material capable of adsorbing carbon dioxide.

The CO₂ unit preferably adsorbs at least 80% of the carbon dioxide present in the gaseous medium; more preferably, at least 90%; and even more preferably, at least 99%.

The CO₂ unit may comprise at least one adsorption module and at least one desorption module. Additionally, the CO₂ unit may include a module configured for alternating operation as an adsorption module and a desorption module. Preferably, the CO₂ unit is structured to enable adsorption or desorption of CO₂ depending on the operational phase.

The CO₂ unit may also include at least one thermal displacement module.

Depending on the operational phase, a module within the CO₂ unit may be configured to perform adsorption, desorption, or thermal displacement.

The device comprises a defined number of modules within the drying unit and CO₂ unit, which may be operated independently during the primary operational phases of “adsorption” and “desorption.” This independent operation enables optimized performance of both the drying unit and the CO₂ unit. This configuration is referred to as a “decoupled system.” The mass airflow through the device is preferably maintained at a constant rate, ensuring that the number of adsorption-phase modules in the drying unit corresponds to the number of CO₂ adsorption modules required to achieve the desired dew point at the inlet of the CO₂ unit.

In some examples, the second airflow channel radially controls the rotatable pre-drying unit. In such configurations, the first and second airflow channels are arranged in parallel. Exhaust air directed through the second airflow channel toward the rotatable pre-drying unit may absorb moisture (i.e., water) to facilitate drying of the sorbent.

The rotatable pre-drying unit may include at least one sorbent for the physisorption of water.

In some examples, the rotatable pre-drying unit may include at least two types of sorbents for the physisorption of water.

The at least one sorbent for water physisorption may be selected from the group consisting of zeolite, graphite, aluminosilicate, metal-organic frameworks (MOF), and silica gel.

Preferably, the at least one sorbent is silica gel. Alternatively, the sorbent may be zeolite.

If two or more sorbents are used, the combination may include silica gel and zeolite. The sorbents may be arranged in layers, with one sorbent facilitating coarse drying of the gaseous medium and the other sorbent facilitating fine drying.

The arrangement of sorbents may be optimized based on airflow patterns. In one example, a sorbent for coarse drying (e.g., silica gel) is positioned in the outer radial region, while a sorbent for fine drying (e.g., zeolite) is positioned in the inner radial region.

Utilizing a combination of at least two sorbents (i.e., two different coatings on the rotatable pre-drying unit) offers advantages, including the ability to achieve a lower dew point compared to a unit with only a single sorbent type. The distribution ratio of the first to second coating is preferably between 70%/30% and 90%/10%, and more preferably between 75%/25% and 80%/20%.

The device may further include at least one intercooler.

Preferably, an intercooler is positioned downstream of the drying unit. Alternatively, an intercooler may be positioned upstream of the CO₂ unit. In some configurations, an intercooler may be arranged between the drying unit and the CO₂ unit.

The intercooler is preferably configured to cool the gaseous medium to a specified temperature, preferably below 15° C., more preferably below 10° C., and even more preferably below 6° C. The gaseous medium is particularly preferably cooled to 5° C.

Additional or larger air conditioning units may enable further cooling to temperatures as low as −20° C. to −40° C. downstream of the drying unit.

The device may further include at least one heat exchanger unit, particularly for heat recovery. The inclusion of a heat exchanger unit reduces external energy demand and enhances overall energy efficiency.

Recovered heat may be used for desorbing water from the drying unit and/or desorbing carbon dioxide from the CO₂ unit.

The device's energy consumption may be further reduced by incorporating at least one heat pump. The heat pump may facilitate energy recovery for desorption within the drying and CO₂ units. The cold exhaust air from the heat pump may also be used for cooling components such as the rotatable pre-drying unit and/or the intercooler.

The device may further comprise at least one blower unit to facilitate airflow. The blower may be positioned at the inlet and/or outlet of the device. The physisorbents used are preferably robust, resistant to aging and commercially available on a large scale. In comparison to chemisorbents, there are generally no signs of aging or degradation in the temperature range used.

The physisorbent may be a homogeneous substance or a mixture. Preferably, the at least one physisorbent is a solid. The at least one physisorbent may be selected from the group consisting of silica gel, zeolite, aluminosilicate, and metal-organic frameworks (MOF).

The drying unit preferably has a layered structure of physisorbents. In some examples, the drying unit includes at least one layer of silica gel and at least one layer of zeolite. The at least one layer of silica gel is preferably positioned in the inlet area of the drying unit, allowing it to perform an initial drying step. The partially dried medium is then directed through at least one zeolite layer to achieve further drying.

Alternatively, the drying unit may comprise at least one layer of silica gel and at least two layers of zeolite. A protective layer of zeolite may be positioned in the inlet area of the drying unit to remove impurities from the gaseous medium, thereby safeguarding subsequent layers. At least one layer of silica gel may be arranged on the protective layer to perform initial drying, after which the partially dried medium is directed through the at least one zeolite layer for further drying.

The ratio of the first layer (e.g., silica gel) to the second layer (e.g., zeolite) may range between 1.5 and 3.5, preferably between 2.0 and 3.0, and more preferably between 2.3 and 2.5.

Ideally, the sorbent(s) of the rotatable pre-drying unit are matched to the physisorbent(s) of the drying unit.

The device may be operated at a CO₂ partial pressure ranging from approximately 380 to 480 ppm, preferably between 400 and 450 ppm, and more preferably at 420 ppm. This variation results in different ratios of CO₂ and H₂O partial pressures. When used under atmospheric conditions, an optimal configuration of the bed heights of the adsorption units may be beneficial.

Preferably, drying is performed so that the medium exiting the drying unit has a moisture content of 0.0196% to 0.007% (dew point −40° C.), preferably between 0.007% and 0.0022% (dew point −50° C.), and more preferably between 0.0022% and 0.0006% (dew point −60° C.).

The CO₂ unit may also have a layered or homogeneous physisorbent structure. Preferably, the CO₂ unit comprises a homogeneous structure of physisorbent(s). The physisorbent may be zeolite, or a mixture of at least two different zeolites.

The CO₂ unit preferably comprises at least two modules. These modules may have identical or different structures. In some examples, each module comprises zeolite as a physisorbent, with all modules having the same structure.

The bed heights or layer thicknesses in the drying unit and CO₂ unit may have a defined ratio. The ratio may range between 1.2 and 2.5, preferably between 1.5 and 2.0, and more preferably between 1.7 and 1.9. The particularly preferred ratio of bed heights or layer thicknesses between the drying unit and the CO₂ unit is 1.8.

As previously described, the gaseous medium may include the atmosphere, ambient air, exhaust gases (e.g., from industrial plants), gas mixtures, or point sources. The gaseous medium comprises, inter alia, carbon dioxide. Preferably, the gaseous medium is ambient air, also referred to herein as air.

In some examples, one step of the disclosed method involves pre-drying the gaseous medium within a first airflow channel using a rotating pre-drying unit. The gaseous medium flows radially toward the axially rotating pre-drying unit.

Pre-drying is preferably performed until the gaseous medium has a moisture content of 0.5 mass %, more preferably 0.25 mass %, and even more preferably 0.1 mass %.

The rotating pre-drying unit may be a sorption wheel or a sorption heat exchanger. A sorption wheel is a wheel-shaped structural component with an outer surface coated with a sorbent. The sorption wheel or sorption heat exchanger rotates while a gaseous medium flows toward it, allowing sorption of specific substances by the sorbent.

In some examples, the rotating pre-drying unit includes at least one sorbent for adsorbing water. The sorbent may be any of those disclosed herein. A single sorbent or a combination of at least two sorbents may be used.

In one embodiment, the rotating pre-drying unit comprises a combination of two sorbents, with a first layer of silica gel and a second layer of zeolite.

The disclosed method further includes drying the pre-dried gaseous medium within a drying unit. The drying unit may comprise multiple modules, as described herein for the device.

The drying unit modules may be in different operational states, wherein at least one module adsorbs H₂O, at least one module desorbs H₂O, and at least two modules perform thermal displacement.

The number of modules in the drying unit in each operational state may be a multiple of the number of individual modules described.

The drying unit may comprise more than four modules, which may be in the operational states of H₂O adsorption, H₂O desorption, and thermal displacement. The ratio of modules in each operational state may be expressed as:

$$Number of drying modules = x desorption modules + y adsorption modules + z thermal displacement modules$$

wherein z=2 or an integer multiple of 2.

Drying may be carried out using at least one suitable material capable of setting the moisture content. The material may be homogeneous or layered. When layered, a drying gradient may be established, where a first layer achieves an initial drying step and a subsequent layer achieves further drying. The layers may comprise at least one physisorbent, as disclosed herein.

During drying, at least 99.0%, more preferably 99.7%, and even more preferably 99.9% of the water content present in the gaseous medium may be adsorbed.

Preferably, the gaseous medium is conditioned before drying. Conditioning primarily ensures that the gaseous medium enters the process at a suitable temperature and/or pressure.

In some examples, the disclosed method includes cooling the gaseous medium prior to CO₂ adsorption. Cooling may be performed using an intercooler or other components for temperature regulation, such as an air-water heat exchanger, air-air heat exchanger, and/or air-air-air heat exchanger.

The gaseous medium is preferably cooled to a defined temperature. The temperature is preferably <15° C., more preferably <10° C., and even more preferably <6° C. Particularly, the gaseous medium is cooled to 5° C.

The disclosed method may further include recovering heat, as previously described.

The energy consumption of the method may be reduced by employing at least one heat pump, as previously discussed.

In some examples, the method includes transporting the gaseous medium using a blower. The blower may correspond to that of the disclosed device.

The blower may be positioned at the inlet and/or outlet of the device to guide the gaseous medium through the system. If the blower is at the inlet, it presses the gaseous medium into the device (e.g., into the pre-conditioning unit). If positioned at the outlet, it creates suction to draw the gaseous medium through the system.

The adsorbed CO₂ may be desorbed by heating under vacuum. The CO₂ adsorption unit is heated to a defined temperature, releasing CO₂, which is then collected with high purity.

Preferably, desorption of CO₂ occurs under vacuum at an absolute pressure of 10 mbar, with no steam required.

The desorbed CO₂ may be discharged with a purity of >80%, more preferably >90%, even more preferably >95%, and in some embodiments >99%.

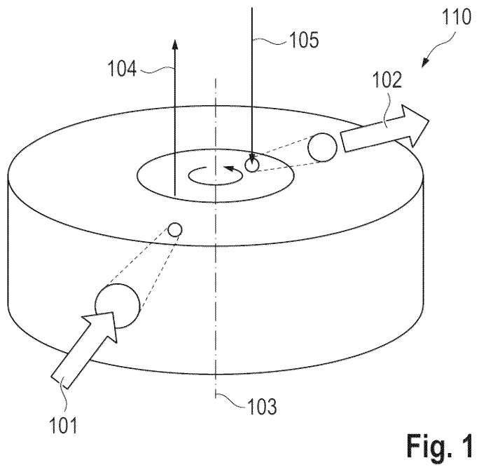

FIG. 1 schematically illustrates an exemplary embodiment of a rotatable pre-drying unit 110. The air inlet for process air on the drying side is represented by 101. Dry regeneration air 105 exits on the regeneration side of rotatable pre-drying unit 110, which rotates about axis 103. The axis of rotation of rotatable pre-drying unit 110 is aligned axially, while process air 101 and regeneration air 105 flow in a radial direction.

In the outer radial area on the drying side, a higher water partial pressure facilitates efficient water adsorption at a lower flow rate. As the radius decreases, the water partial pressure drops due to progressive adsorption. Simultaneously, the flow rate increases, thereby enhancing adsorption kinetics and ensuring effective drying even at lower water partial pressures. Dried process air is represented by 104, while dry regeneration air is represented by 105. Rotatable pre-drying unit 110 may include at least one coating of at least one sorbent for water on its outer surface, toward which the air flows. Moist exhaust air is represented by 102.

Alternatively, a specific coating pattern of sorbents may be applied for this radial airflow arrangement. In the outer radial area, a sorbent optimized for rough drying (e.g., silica gel) is advantageous, while in the inner radial area, a sorbent optimized for fine drying (e.g., zeolite) is preferable.

The rotatable pre-drying unit illustrated in FIG. 1 may be a sorption wheel or a sorption heat exchanger.

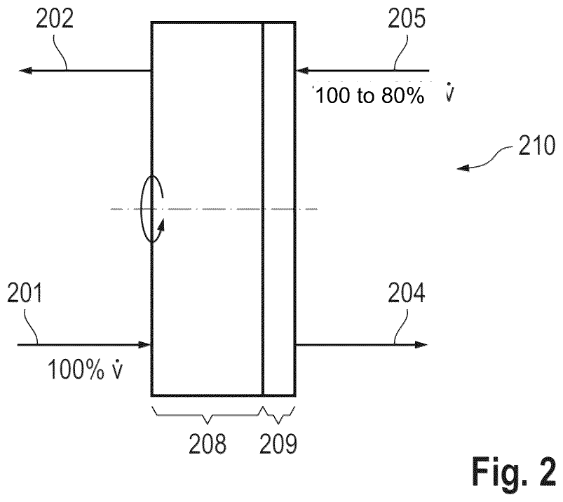

FIG. 2 schematically illustrates an exemplary embodiment of a coating on the outer circumferential surface of a rotatable pre-drying unit 210. The air inlet for process air is shown as 201. The air passes through rotatable pre-drying unit 210 and exits as dry process air 204. Dry regeneration air 205 enters rotatable pre-drying unit 210 and exits as moist exhaust air 202. Rotatable pre-drying unit 210 rotates about the axis shown.

Reference 208 represents a first coating layer with a sorbent particularly suited for rough pre-drying of the gaseous medium (e.g., air) at higher partial pressures, such as silica gel. 209 represents a second coating layer with a sorbent optimized for fine drying of the gaseous medium at lower partial pressures, such as zeolite.

The parameter \tilde{v} represents the volume flow, where 80% to a maximum of 100% of the volume flow is utilized for regenerating the pre-drying unit, while the remaining portion is allocated for desorption steps in the drying unit and CO₂ unit.

The layered coating pattern provides advantages by enabling the dry process air to reach an even lower dew point compared to a rotatable pre-drying unit (e.g., a sorption heat exchanger) with only a single coating type. The preferred distribution ratio between the first and second coatings is 70/30% to 90/10%.

The rotatable pre-drying unit illustrated in FIG. 2 may be a sorption wheel or a sorption heat exchanger.

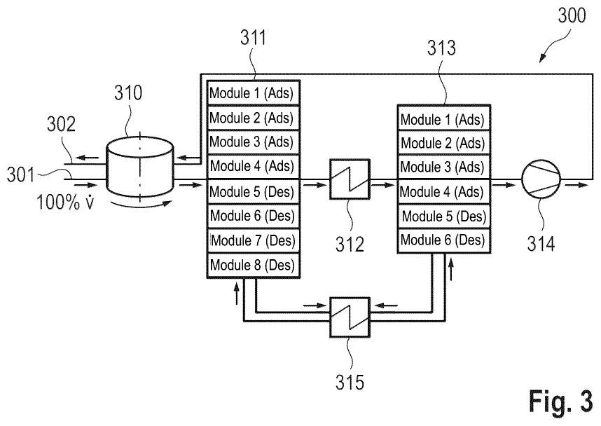

FIG. 3 schematically illustrates an exemplary embodiment of a device 300 for recovering carbon dioxide. Pre-drying is performed by means of a rotatable pre-drying unit 310 (e.g., a sorption heat exchanger). Gaseous medium 301 (e.g., air) enters rotatable pre-drying unit 310 radially and exits in a pre-dried state into drying unit 311 for fine drying.

Drying unit 311 comprises eight modules, with four modules in adsorption mode (Ads) and four in desorption mode (Des). A portion of the finely dried gaseous medium enters an intercooler 312, where it is cooled before being directed to CO₂ unit 313. CO₂ unit 313 comprises six modules, with four modules in adsorption mode (Ads) and two in desorption mode (Des).

A portion of the gaseous medium exiting CO₂ unit 313 is returned to rotatable pre-drying unit 310 by means of blower 314. This returned medium is used to dry the sorbent within rotatable pre-drying unit 310. Moist exhaust air exits the system as 302.

Another portion of the gaseous medium exiting drying unit 311 is directed to heat exchanger units for heat recovery 315. The recovered heat is utilized to desorb CO₂ from the CO₂ unit 313 modules. Additionally, a portion of the gaseous medium exiting CO₂ unit 313 may enter heat exchanger units 315, where the heat is used to desorb water from the drying unit 311 modules.

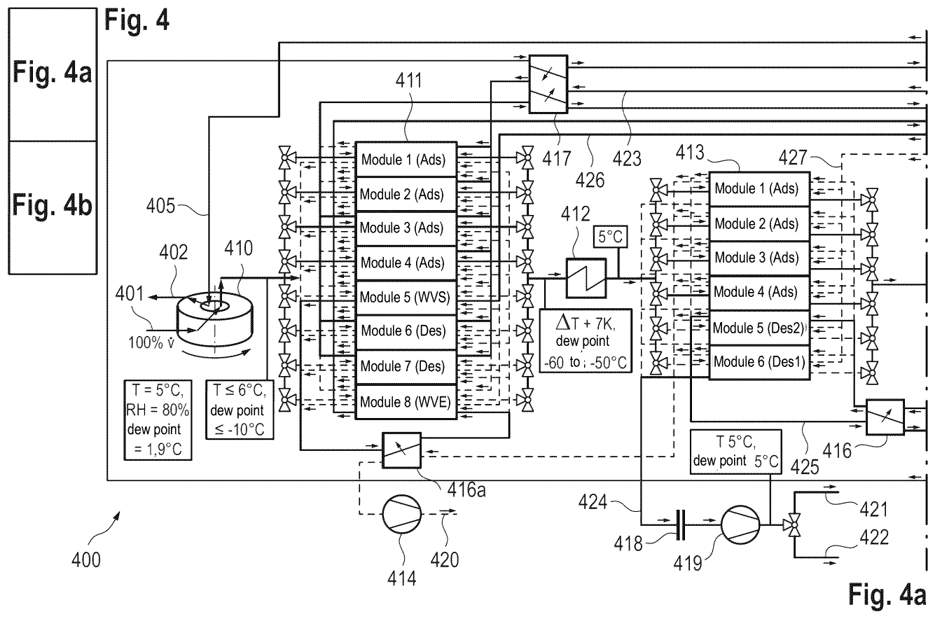

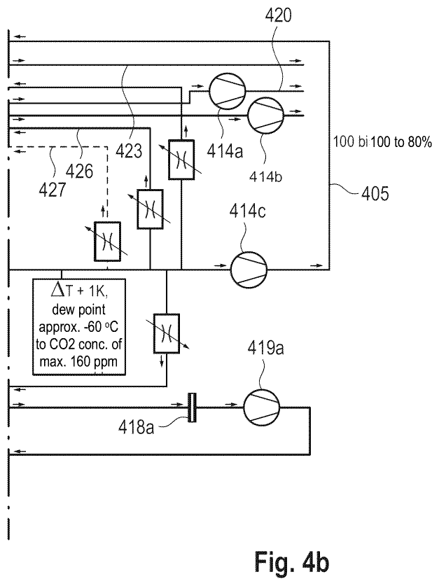

FIG. 4 schematically illustrates another exemplary embodiment of a device 400 for recovering carbon dioxide, which operates using a direct air capture (DAC) method. The system primarily comprises a rotatable pre-drying unit 410, a drying unit 411 for fine drying, an intercooler 412, a CO₂ adsorption unit 413, multiple heat exchanger units 416, 417 for heat recovery, and a blower 414 a, b, c arranged in suction mode.

Dry regeneration air 405 may be used for regenerating rotatable pre-drying unit 410.

The system includes a defined number of drying modules within drying unit 411 and CO₂ modules within CO₂ unit 413, which are operated independently in the main operating phases of “adsorption” (Ads) and “desorption” (Des). This independent operation optimizes both drying and CO₂ recovery, forming what is referred to as a decoupled system.

The air mass flow through the system remains constant, ensuring that the number of drying modules in the adsorption phase corresponds to the required CO₂ adsorption modules, maintaining the necessary dew point temperature condition at the inlet of CO₂ unit 413.

The proposed system consists of 8 drying modules and 6 CO₂ modules, with 4 drying unit modules and 4 CO₂ unit modules in adsorption mode at any given time. The number of modules is determined based on the required process times for the drying and CO₂ units, where drying unit adsorption-to-desorption time is 1:1, and CO₂ unit adsorption-to-desorption time is 1:0.5.

The total process time for a drying module may be 4 hours (2 hours adsorption, 2 hours desorption), while the total process time for a CO₂ module may be 4.5 hours (3 hours adsorption, 1.5 hours desorption).

However, alternative configurations with different numbers of drying and CO₂ modules may be employed, provided that the total mass flow through the adsorption path remains constant and desorption of the drying and CO₂ modules is completed before their subsequent adsorption cycles.

Gaseous medium 401 (e.g., moist ambient air) enters rotatable pre-drying unit 410 (e.g., a sorption heat exchanger) on the supply air side. Water is adsorbed on the sorption material (preferably silica gel, zeolite, or a combination thereof), and the medium exits rotatable pre-drying unit 410 at 80% relative humidity with a temperature of 6° C. and a dew point of −10° C.

Since zeolites preferentially adsorb water over CO₂, the water content of the gaseous medium must be further reduced before CO₂ adsorption. The gaseous medium is therefore directed to drying unit 411 for fine drying to a dew point of at least −50° C., preferably −60° C.

Within drying unit 411, water is separated by adsorption onto a sorbent, preferably Zeolite Type 13X. The total bed height in drying unit 411 may be 135 mm, similar to that of the CO₂ modules in CO₂ unit 413.

The inflow area of drying unit 411 is designed to achieve an average inflow velocity of 0.2 m/s upstream of the sorption material. The ratio of inflow areas between drying unit 411 and CO₂ unit 413 is preferably 1:1, though ratios between 0.75 and 1.0 are also possible.

This mode enables a quasi-continuous operation of four drying modules in adsorption and four drying modules in desorption, each of which is operated for two hours in adsorption and two hours in desorption. The gaseous medium from drying unit 411 can be discharged as exhaust air 420 via an air-air heat exchanger 417 by means of blower 414a.

During the desorption of the CO₂ modules, the module is evacuated to an absolute pressure of 10 mbar in the first desorption phase. The sorption material is then heated to 150° C. by means of the internal heat exchanger (120° C. to 200° C. are also possible). In doing so, the CO₂ is desorbed and continuously extracted by vacuum pump 419. If the purity is sufficient (>95%, preferably >99%), the desorbed CO₂ is passed into product path 422. This first desorption phase lasts 30 minutes.

Since it cannot be prevented that a small amount of residual moisture enters the CO₂ stage during adsorption (due to slight water breakthrough downstream of drying unit 411), CO₂ desorption is followed by H₂O desorption under negative pressure to remove residual H₂O. For this purpose, a dry gaseous medium of 3.4% mass flow proportion of the adsorption mass flow (0.1 to 5% is also possible) is introduced while raising the desorption temperature to 200° C. (150° C. to 200° C. is also possible). This dry gaseous medium is continuously extracted by vacuum pump 419, while maintaining a pressure of 100 mbar absolute (10 to 800 mbar is also possible) in a 2-stage desorption process. The dry gaseous medium introduced for desorption is passed through an air-air heat exchanger 416 and preheated with the hot desorption air exiting this desorption phase 425, thereby recovering a portion of the desorption energy.

Upstream of vacuum pump 419, the desorbed water is condensed at condenser 418 (outlet temperature 5° C.), reducing the compressor workload of vacuum pump 419. Due to compression, the desorption air leaves vacuum pump 419 at a temperature greater than 150° C. The hot desorption air is then passed to drying unit 411 and used via an air-air heat exchanger 417 to preheat the purge air of the desorption phase. The second desorption phase preferably lasts 35 minutes.

To recover the heat stored in the sorption material, a thermal transfer phase 427 follows, in which dry gaseous medium is passed through the module under atmospheric pressure at a mass flow rate of 7.5% of the adsorption mass flow (0.5 to 15% is also possible). As a result, the sorption material cools down and is immediately ready for absorption in the subsequent adsorption phase. The hot exhaust air from thermal displacement phase 427 is directed to drying unit 411 in order to additionally heat the air from the thermal displacement phase between the drying modules via an air-air heat exchanger 416a. Thermal displacement phase 427 of the CO₂ modules in CO₂ unit 413 lasts 25 minutes.

This mode enables a quasi-continuous operation of four CO₂ modules in adsorption and two CO₂ modules in desorption, each of which is operated for three hours in adsorption and 1.5 hours in desorption. The modules of CO₂ unit 413 can be operated with a time offset of 45 minutes each or with an offset of 60-30-60-30-60-30 minutes. Drying unit 411 and CO₂ unit 413 can be operated offset from one another as desired.

From CO₂ unit 413, a portion of the gaseous medium can be guided via a desorption path 424 through a condenser 418 by means of a vacuum pump 419 and divided into residual air 421 and CO₂ product stream 422 with a purity >99%.

For fine drying of the CO₂ unit, the H₂O stored in the sorbent material can be discharged as moist exhaust air 420 via a desorption path 425, through an air-air heat exchanger 416, a condenser 418a, a vacuum pump 419a, and an air-air-air heat exchanger 417.

A blower 414c is positioned downstream of CO₂ unit 413, which draws the gaseous medium through the system. As a good compromise between pressure loss across the adsorption units and CO₂ yield, an average inflow velocity of 0.2 m/s across the front surfaces of the CO₂ adsorber units is preferred (0.1 to 0.4 m/s is also possible).

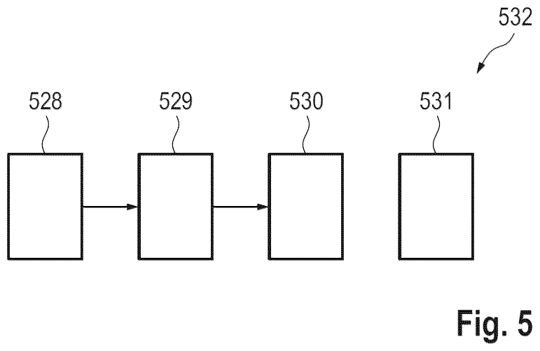

FIG. 5 schematically illustrates an exemplary embodiment of a method 532 for recovering CO₂. First, a gaseous medium is provided in a first airflow channel 528. The gaseous medium is then pre-dried in a rotating pre-drying unit 529, wherein the rotating pre-drying unit rotates axially, and the first airflow channel controls the rotating pre-drying unit radially.

The pre-dried gaseous medium is then dried in at least one drying unit 530.

In a subsequent step 531, CO₂ is adsorbed from the at least pre-dried gaseous medium in a CO₂ unit, while simultaneously recovering CO₂ by desorbing CO₂ in the CO₂ unit.

### LIST OF REFERENCE NUMERALS

300, 400 device for recovering carbon dioxide
101, 201, 301, 401 air inlet
102, 202, 302, 402 moist exhaust air
103, 203 axis
104, 204 dried process air
105, 205, 405 dry regeneration air
206 dry regeneration air
208 coating
110, 210, 310, 410 rotatable pre-drying unit
311, 411 drying unit
312, 412 intercooler
313, 413 CO₂ unit
314, 414a, b, cblower
315 heat exchanger units for heat recovery
416, 416a air-air heat exchanger
417 air-air-air heat exchanger
418, 418a condenser
419, 419a vacuum pump
420 moist exhaust air
421 residual air
422 CO₂ product stream
423 path desorption
424 path desorption 1
425 path desorption 2
426 path thermal displacement drying unit
427 path thermal displacement CO₂
528 providing a gaseous medium in a first air flow channel
529 pre-drying of the gaseous medium in a rotating drying unit
530 drying the pre-dried gaseous medium in a drying unit
531 adsorbing CO₂ from the at least pre-dried gaseous medium and simultaneously recovering CO₂ by desorbing CO₂ in a CO₂ unit
532 method for recovering CO₂

1. A device for recovering carbon dioxide from a gaseous medium, comprising:
a first air flow channel configured to direct the gaseous medium;
a second air flow channel configured to direct exhaust air from the device; and
at least one rotatable pre-drying unit comprising at least one sorbent for the physisorption of water,
wherein the at least one rotatable pre-drying unit is configured to rotate axially, and wherein the first air flow channel is configured to control the at least one rotatable pre-drying unit radially.

2. The device of claim 1, further comprising at least one drying unit and at least one CO₂ unit.

3. The device of claim 2, wherein the at least one CO₂ unit comprises at least one adsorption module and at least one desorption module.

4. The device of claim 2, wherein the at least one drying unit comprises at least four modules, the at least four modules comprising at least one desorption module, at least two thermal displacement modules, and at least one adsorption module.

5. The device of claim 1, wherein the second air flow channel is configured to control the at least one rotatable pre-drying unit axially.

6. The device of claim 1, wherein the at least one rotatable pre-drying unit comprises at least two sorbents for the physisorption of water.

7. The device of claim 6, wherein the at least two sorbents comprise at least one sorbent selected from the group consisting of zeolite, graphite, aluminosilicate, metal-organic framework (MOF), and silica gel.

8. A method for recovering carbon dioxide from a gaseous medium, comprising:
providing the gaseous medium in a first air flow channel;
pre-drying the gaseous medium in at least one rotatable pre-drying unit, wherein the at least one rotatable pre-drying unit is configured to rotate axially and the first air flow channel is configured to control the at least one rotatable pre-drying unit radially;
drying the pre-dried gaseous medium in at least one drying unit; and
adsorbing carbon dioxide from the dried gaseous medium in at least one CO₂ unit while simultaneously desorbing carbon dioxide in the at least one CO₂ unit.

9. The method of claim 8, wherein the at least one rotatable pre-drying unit comprises at least one sorbent for the physisorption of water.

10. The method of claim 9, wherein the at least one sorbent comprises at least one sorbent selected from the group consisting of zeolite, graphite, aluminosilicate, metal-organic framework (MOF), and silica gel.

11. The method of claim 8, wherein the at least one drying unit comprises at least four modules, the at least four modules comprising at least one desorption module, at least two thermal displacement modules, and at least one adsorption module.

12. The method of claim 8, wherein the at least one CO₂ unit comprises at least one adsorption module and at least one desorption module.

13. The method of claim 8, further comprising controlling the at least one rotatable pre-drying unit axially via a second air flow channel.

14. A device for recovering carbon dioxide from a gaseous medium, comprising:
a first air flow channel configured to direct the gaseous medium;
a second air flow channel configured to direct exhaust air from the device;
at least one rotatable pre-drying unit comprising at least one sorbent for the physisorption of water, wherein the at least one rotatable pre-drying unit is configured to rotate axially, and wherein the first air flow channel is configured to control the at least one rotatable pre-drying unit radially;
at least one drying unit configured to receive the pre-dried gaseous medium from the at least one rotatable pre-drying unit;
at least one CO₂ unit configured to receive the dried gaseous medium from the at least one drying unit and adsorb carbon dioxide while simultaneously desorbing carbon dioxide; and
at least one heat exchanger unit configured to transfer heat between at least one of the first air flow channel and the second air flow channel, the at least one drying unit, and the at least one CO₂ unit to improve energy efficiency of the device.

15. The device of claim 14, further comprising at least one intercooler configured to reduce the temperature of the dried gaseous medium before the gaseous medium enters the at least one CO₂ unit.

16. The device of claim 14, wherein the at least one heat exchanger unit is configured to recover thermal energy from a desorption phase of the at least one CO₂ unit and transfer the recovered thermal energy to a regeneration phase of the at least one drying unit.

17. The device of claim 14, wherein the at least one drying unit comprises at least one thermal displacement module configured to store and redistribute heat between different operating phases of the at least one drying unit.

18. The device of claim 14, wherein the at least one CO₂ unit comprises a plurality of adsorption modules and desorption modules, and wherein the device is configured to operate the plurality of modules in a cyclic manner to provide continuous carbon dioxide recovery.

19. The device of claim 14, wherein the at least one rotatable pre-drying unit comprises a sorbent coating having at least two layers, the at least two layers including a first sorbent configured for rough pre-drying of the gaseous medium and a second sorbent configured for fine drying of the gaseous medium.

20. The device of claim 14, wherein the at least one drying unit and the at least one CO₂ unit are configured as a decoupled system, wherein an air mass flow through the at least one drying unit is independent of an air mass flow through the at least one CO₂ unit.
